(19) United States
(12) Patent Application Publication
(10) Pub. No.: US 2013/0264093 A1
(43) Pub. Date: Oct. 10, 2013

(54) Electrical Conductor for Transporting Electrical Energy and Corresponding Production Method

(71) Applicants: Lluis Riera Fontana, Barcelona (ES); Nuria Ferrer Crusellas, Barcelona (ES); Miquel Garcia Zamora, Barcelona (ES); Oriol Guixa Arderiu, Barcelona (ES); Cristina Garcia Marsa, Barcelona (ES); Ferran Espiell Alvarez, Barcelona (ES)

(72) Inventors: Lluis Riera Fontana, Barcelona (ES); Nuria Ferrer Crusellas, Barcelona (ES); Miquel Garcia Zamora, Barcelona (ES); Oriol Guixa Arderiu, Barcelona (ES); Cristina Garcia Marsa, Barcelona (ES); Ferran Espiell Alvarez, Barcelona (ES)

(73) Assignee: LA FARGA LACAMBRA, S.A.U., Barcelona (ES)

(21) Appl. No.: 13/825,154

(22) PCT Filed: Jan. 24, 2012
(86) PCT No.: PCT/ES12/70036

§ 371 Date: Jun. 4, 2013

(30) Foreign Application Priority Data
Jan. 24, 2011 (EP) 11151788.4
Nov. 24, 2011 (ES) P201131896

(51) Int. Cl. H01B 7/30; H01B 7/14; H01B 3/02

(52) U.S. Cl. CPC H01B 7/30; H01B 3/025; H01B 7/14
USPC 174/113 R

(57) ABSTRACT

An electrical conductor for transmission of electrical power, having a total cross-section equal to or above 10 mm² and comprising a plurality of stranded filamentary members, where at least one of the filamentary members is made from microalloyed copper or microalloyed aluminium having annealing temperatures higher than 250° C., and has the side surface thereof totally coated with a fluorinated polymer. The conductor has a better behavior relative to the skin effect and allows operation at high temperatures. Furthermore, if the electrical conductor is suspended, it has a smaller sag and prevents or reduces the accumulation of ice and/or snow.

### FIELD OF THE INVENTION

The invention relates to an electrical conductor for the transmission of electrical power, where the conductor has a total cross-sectional area equal to or over 10 mm2 and comprises a plurality of stranded filamentary members. The filamentary members can be, for example, wires of circular cross-section, wires of trapezoidal cross-section, wires of triangular cross-section, as well as other possible sections.

The invention also relates to a process for manufacturing an electrical conductor according to the invention.

The invention also relates to applications of conductors according to the invention, such as for example overhead power lines and submarine cables that comprise a conductor according to the invention.

### STATE OF THE ART

In the field of the transmission and distribution of electrical power by means of overhead lines aluminum-steel (ACSR) electrical conductors are well known.

The consumption of electrical power is constantly increasing. This requires, on the one hand, new facilities of increasingly greater capacity and, on the other hand requires the introduction of changes in the present facilities so that they can carry more power

### SUMMARY OF THE INVENTION

It is an object of the invention to contribute novel solutions to this situation. This purpose is achieved by means of an electrical conductor of the type mentioned hereinabove characterized in that at least one of the filamentary members (and preferably all of them) is made from unannealed microalloyed copper, with a minimum copper content of 98 wt %, or from a unannealed microalloyed aluminum, with a minimum aluminum content of 90 wt %, and has its side surface totally coated with a fluorinated polymer.

The fluorinated polymers are those polymers based on fluorocarbons, with multiple C—F bonds. Within the fluorinated polymer group the following are to be found:
Polyvinyl fluorides (PVF)
Polyvinylidene fluorides (PVDF)
Perfluoroalkoxys (PFA)
Polytetrafluoroethylene (PTFE)
Fluorinated ethylene propylene (FEP)
Ethylene tetrafluoroethylene (ETFE)
Ethylene chlorotrifluoroethylene (ECTFE)
Perfluorinated elastomers
Chlorotrifluoroethylene vinylidene fluoride
Perfluoropolyether
Polichlorotrifluoroethylene

In fact, an effect known as “skin effect” occurs in the electrical conductors. In direct current, the current density is similar throughout the conductor, but in alternating current a greater current density is observed on the surface than in the center. This phenomenon is known as skin effect and means that the resistance of a conductor to the flow of alternating current is greater than to the flow of direct current. The skin effect is due to the variation of the magnetic field being greater in the center of the conductor, giving rise to a greater inductive reactance, and, due to this, to a smaller intensity in the center of the conductor and a larger intensity at the periphery. At high frequencies the electrons tend to circulate by the most external zone of the conductor, in corona form, instead of over the entire section, whereby, in fact, the effective cross section over which these electrons circulate is reduced, increasing the resistance of the conductor. In the case of stranded electrical conductors, since the wires (in general, the filamentary members) are in mutual electrical contact, the skin effect is observed as if the stranded electrical conductor were a single conductor of greater cross section. Nevertheless, when at least one filamentary member is coated with a fluorinated polymer, the insulating properties of the fluorinated polymer allow the coated filamentary member to be insulated from the rest, whereby the skin effect affects the filamentary member in a way isolated from the rest. The result is that the overall skin effect is smaller, allowing the electrical resistance of the electrical conductor to be reduced in alternating current.

The improved behavior to the skin effect is thanks to the insulating properties of the fluorinated compound. Furthermore, the fluorinated compounds withstand high temperatures, allowing the conductor to work at high temperatures without the coating becoming degraded.

This combination of advantages makes the conductors according to the invention particularly appropriate for any application related to the transmission of electrical power.

The corona effect is an electrical phenomenon that takes place in electrical conductors and appears as a luminous glow around them. Since the conductors usually have a circular cross section, the glow adopts the form of a corona, whereby the name of the phenomenon.

The corona effect is caused by the ionization of the air surrounding the conductor due to the voltage levels in the line. When the air molecules ionize, they are capable of conducting the electrical current and part of the electrons flowing along the line move on to flow through the air. The intensity of the corona effect, therefore, may be quantified according to the color of the glow, which will be reddish in slight cases and bluish in the more severe ones. The fluorinated polymer coating, specially applied in the outer filamentary members of the conductor, increases by up to 35% the voltage as from which the corona effect takes place (dielectric breakdown voltage), and therefore the power losses caused by the corona effect are reduced.

Additionally, the fluorinated polymer is highly hydrophobic. This is a particularly useful feature since it prevents or reduces the accumulation of ice and/or snow on the electrical conductor, above all if at least all the external filamentary members of the electrical conductor have their side surface totally coated with the fluorinated polymer. Thus, an advantageous application of the conductors according to the invention is the installation thereof in overhead power lines for the transmission of electrical power.

Another additional advantage is derived from the fact that the electrical conductor according to the invention has a smaller elastic modulus, due to the low coefficient of friction of the fluorinated polymer. Thus, conventional electrical conductors (without the coating according to the invention) having an elastic modulus between 30,000 and 40,000 MPa (megapascals), then have an elastic modulus of between 4,000 and 10,000 MPa if the filamentary members are coated according to the invention. As a result of this, the suspended electrical conductor will have a smaller sag. In this sense, it is particularly advantageous for the fluorinated polymer to have a static coefficient of friction comprised between 0.08 and 0.2, and a dynamic coefficient of friction comprised between 0.02 and 0.15.

Another particularly interesting application may be the inclusion of the conductors according to the invention in submarine cables for the transmission of electrical power.

As will be seen hereinafter, the present invention is appropriate for any type of electrical conductor although the preferred applications are for electrical conductors in which the filamentary members are wires of circular cross section and have a diameter of between 0.3 and 5 mm each, with a total diameter of the cord of between 3.5 and 35 mm. The direction of lay of the electrical conductor can be right, left or in alternating rings. Furthermore, it can have wires of various diameters in the same cord, and even wire combinations with other geometries (wires of trapezoidal, triangular cross section, tubes, etc.). It is also advantageous for the electrical conductor to be a conductor stranded with wires of circular, trapezoidal and/or triangular cross section, without a tubular core, which allows solutions with a smaller catenary sag to be obtained.

Preferably the electrical conductor has a plurality of fluorinated polymer coated filamentary members (that is to say with the side surface thereof totally coated with the fluorinated polymer), where said coated filamentary members are distributed in such a way that each of the filamentary members not coated with fluorinated polymer is only in contact with fluorinated polymer coated filamentary members. Indeed, with the non-coated filamentary member being in contact only with coated filamentary members, the non-coated filamentary member is really isolated from the other filamentary members, whereby its behavior relative to the skin effect is as if it were coated.

Preferably the filamentary member is made from microalloyed copper with an annealing temperature of above 250° C. Indeed, these materials have proved to be particularly appropriate for the transmission of electrical power by overhead lines. They combine high electrical properties with good mechanical properties, a good resistance to wear and a low thermal fluence. Furthermore their high annealing temperature allows the application thereto of fluorinated polymers requiring high curing temperatures.

Advantageously the composition of the microalloyed copper comprises the following weight percentages:
Zn: 0.001-0.015
Pb: 0.005-0.050
Sn: 0.005-0.600
Ni: 0.002-0.050
As: 0.001-0.005
Sb: 0.001-0.010
Ag: 0.002-0.012
Mg<0.4

Preferably the mechanical strength of the electrical conductor is between 400 and 700 MPa.

In another preferred configuration, the filamentary member is made from microalloyed aluminum with an annealing temperature of above 250° C. The main advantage of this material is its lightness and its high annealing temperature also allows the application thereto of fluorinated polymers requiring high curing temperatures.

Advantageously the composition of the microalloyed aluminum comprises the following weight percentages:
Ag≦0.020
As≦0.010
Fe≦0.800
Ni≦0.015
Mg≦0.900
Pb≦0.020
Si≦0.900
Ti≦1.800
Zr≦0.900
Zn≦0.020
Se≦0.010
Te≦0.010

where the sum of the percentages of these components is at least 0.25 wt % of the total alloy.

Either of the following two compositions of microalloyed aluminum (in wt %) are particularly advantageous
Mg: 0.60-0.90
Si: 0.55-0.85
Al: rest

and
Zr: 0.15-0.25
Fe: 0.1-0.2
Zn: 0.01-0.015
Ti: 0.005
Al: rest

The fluorinated polymer is preferably polytetrafluoroethylene (PTFE) or a derivative thereof. Additionally to the properties already indicated previously, these compounds are very flexible, chemically inert, resistant to sunlight and have non-stick properties.

It is particularly advantageous for the fluorinated polymer to be a polytetrafluoroethylene reinforced with heat resistant resins that is applied in thicknesses (of dry film) comprised between 10 and 35 microns, and to allow continuous operating temperatures of above 220° C. and intermittent operating temperatures of above 250° C.

The electrical conductors according to the invention have therefore improved properties, which makes them suitable, for example, for replacing the ACSR electrical conductors. They have a greater capacity for the transmission of electrical power (since they allow higher service temperatures to be reached and, in the case of the microalloyed copper, have a lower electrical resistance) but they do not increase the suspended weight, whereby they can be used with the existing structures, with no need to reinforce them. Furthermore, in adverse meteorological conditions they prevent or reduce the accumulation of ice and/or snow, which avoids the fall/breakage of the electrical conductors or of the elements that support them.

The invention also has as object a process for the manufacture of an electrical conductor according to the invention characterized in that it comprises a step of coating at least one of the filamentary members with a fluorinated polymer and later stranding of said electrical conductor. Preferably the coating step includes a step of applying said fluorinated polymer by spraying, dipping or impregnation using rollers, and a step of curing the fluorinated polymer at a temperature of above 200° C, preferably above 220° C. Indeed, at these curing temperatures the optimal properties of the fluorinated polymer are obtained, and for that reason it is advantageous for the material of the filamentary members to have an annealing temperature above the curing temperature of the fluorinated polymer.

### BRIEF DESCRIPTION OF THE DRAWINGS

Other advantages and features of the invention are appraised from the following description, in which, without any limiting nature, preferred embodiments of the invention are disclosed, with reference to the accompanying drawings, in which:

FIGS. 1 to 5 show cross sections of electrical conductors according to the invention.

### DETAILED DESCRIPTION OF EMBODIMENTS OF THE INVENTION

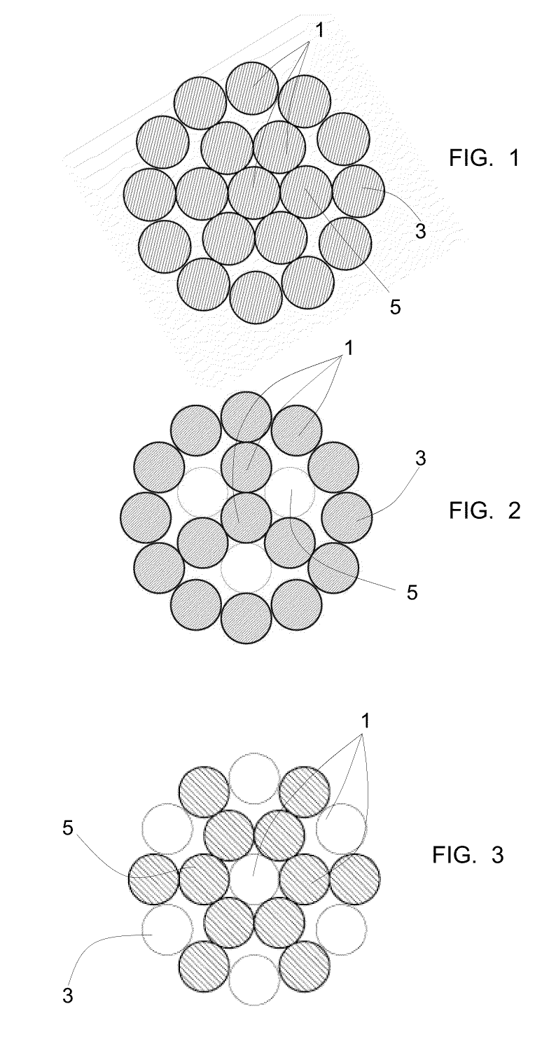

FIGS. 1 to 5 show various alternatives of electrical conductors according to the invention. Those filamentary members that are coated with a fluorinated polymer have been shown with a hatched cross section and those that do not have a fluorinated polymer coating have been shown with a plain cross section. In general, the electrical conductors are made from microalloyed copper according to the previously indicated composition.

FIG. 1 shows an electrical conductor of 19 wires 1. Each wire 1 has a diameter of 2.5 mm and the electrical conductor has a cross section of 95 mm². In this case, all the filamentary members (which are wires 1 of circular cross section) are coated.

FIG. 2 also shows an electrical conductor of 19 wires 1. Each wire 1 has a diameter of 3.5 mm and the electrical conductor has a cross section of 125 mm². In this case, all the wires 1 of the outer ring 3 and the internal wire are coated, whereas those of the intermediate ring 5 are coated alternately. In this way, there is obtained the maximum reduction of the skin effect (since there is no electrical connection between any of the wires 1) and the maximum hydrophobic effect (since all the external surface is coated with the hydrophobic polymer). Nevertheless, it has not been necessary to coat three of the wires 1.

FIG. 3 again shows an electrical conductor of 19 wires 1. In this case, each wire 1 has a diameter of 1.5 mm and the electrical conductor has a cross section of 60 mm². The electrical conductor presents another possible combination of coated and uncoated wires 1 that, for example, could be used in applications in which the hydrophobic effect is not important.

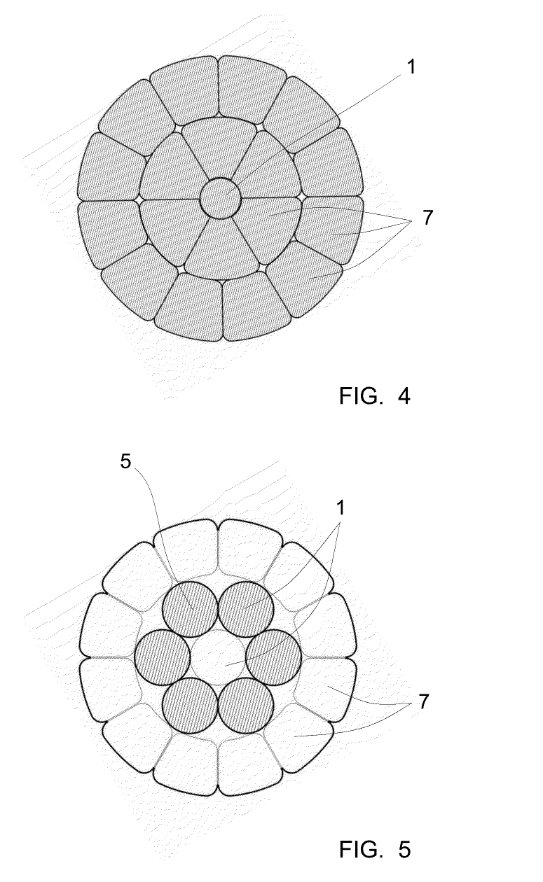

The electrical conductor of FIG. 4 has one wire 1 in the interior and two layers of trapezoidal wires 7. All the filamentary members are coated with a fluorinated polymer.

FIG. 5 shows a possible combination of techniques. On the one hand, the electrical conductor has the filamentary members of the intermediate ring 5 (wires 1 of circular cross section) coated with a fluorinated polymer, whereas the external filamentary members (which are trapezoidal wires 7) are coated only on the part of their side surface that is in contact with the environment. With this geometry a good control of the skin effect is obtained, since intermediate ring 5 effectively insulates the three layers of filamentary members (from the point of view of the skin effect it is not important for the filamentary members that are at the same distance from the center, that is to say, in the same ring, to be in electrical contact with each other), whereas also a good hydrophobicity is obtained. Furthermore, in general, the fact that an electrical conductor has its outer ring 3 formed with trapezoidal wires 7 reduces the accumulation of snow/ice since it has a smoother external surface and without recesses.

### Example 1

A comparative test was carried out between a 95 mm² microalloyed copper cord with all the wires coated with Xylan 1514® (a polymer composed of polytetrafluoroethylene reinforced with heat resistant resins marketed by Whitford Plastics Ltd. It has a static coefficient of friction of 0.15, and a dynamic coefficient of friction of 0.06), and a cord of the same composition and geometry but without using the coating. The installation was 70 meters in length. When the same voltage was applied to both electrical conductors, the following results were obtained:
with the coated cord, a current intensity of 595 A was reached and a sag of 42 cm
with the uncoated cord, a current intensity of 555 A was reached and a sag of 62 cm
in both cases, the conductor temperature reached 120° C.

Conclusions: with the electrical conductor formed by coated wires 8% more electrical current is transmitted, and the installation has 48% less sag.

### Example 2

A type LA-180 ACSR cable (180 mm²) can work continuously at a maximum temperature of 85° C., which corresponds to a maximum intensity of 425 A. An equivalent conductor thereto, with no need to reinforce the structures, is equivalent to the 95 mm2 microalloyed copper conductor (object of the present invention). This conductor can operate continuously at up to 150° C., and under these conditions, if the wires thereof are coated alternately with fluorinated polymer it can transport an intensity of 700 A. That is to say, 65% more electrical power.

### Example 3

Process of application of the fluorinated polymer:
1. Cleaning of the substrate (degreasing)
2. Spraying. It may also be deposited by a dipping or roller impregnation process.
3. If the fluorinated polymer comes in liquid state, it requires drying: 10 min at from 100 to 175° C.
4. Curing: less than 30 minutes at temperatures between 220° C. and 275° C.

As the curing conditions are at temperatures of above 220° C., if this process is carried out on materials having a lower annealing temperature, their mechanical properties will be affected negatively. Therefore it is particularly advantageous for the conductive material to have an annealing temperature of above the curing temperature. It must be remembered that pure aluminum has an annealing temperature below 120° C., and the annealing temperature of electrolytic copper (ETP) is below 200° C.

1. An electrical conductor for the transmission of electrical power, where said conductor has a total cross section equal to or more than 10 mm² and comprises a plurality of stranded filamentary members wherein at least one of said filamentary members is made from unannealed microalloyed copper, with a minimum copper content of 98 wt %, or from unannealed microalloyed aluminum, with a minimum aluminum content of 90 wt %, and has its side surface totally coated with a fluorinated polymer.

2. The electrical conductor according to claim 1, wherein it is a stranded electrical conductor having wires of circular, trapezoidal and/or triangular cross section, without a tubular core.

3. The electrical conductor according to claim 1, wherein it is formed by wires of circular cross section having a diameter of between 0.3 mm and 5 mm.

4. The electrical conductor according to claim 1, wherein it has a plurality of filamentary members coated with fluorinated polymer, where said coated filamentary members are distributed in such a way that each of the filamentary members not coated with fluorinated polymer is only in contact with filamentary members coated with fluorinated polymer.

5. The electrical conductor according to claim 1, wherein all the external filamentary members thereof have their side surface totally coated with said fluorinated polymer.

6. The electrical conductor according to claim 1, wherein said microalloyed copper has an annealing temperature higher than the curing temperature of said fluorinated polymer.

7. The electrical conductor according to claim 1, wherein said microalloyed copper has an annealing temperature of above 250° C.

8. The electrical conductor according to claim 1, wherein the composition of said microalloyed copper comprises the following weight percentages:
Zn: 0.001-0.015
Pb: 0.005-0.050
Sn: 0.005-0.600
Ni: 0.002-0.050
As: 0.001-0.005
Sb: 0.001-0.010
Ag: 0.002-0.012
Mg<0.4

9. The electrical conductor according to claim 1, wherein said microalloyed aluminum has an annealing temperature higher than the curing temperature of said fluorinated polymer.

10. The electrical conductor according to claim 1, wherein said microalloyed aluminum has an annealing temperature of above 250° C.

11. The electrical conductor according to claim 1, wherein the composition of said microalloyed aluminum comprises the following weight percentages
Ag≦0.020
As≦0.010
Fe≦0.800
Ni≦0.015
Mg≦0.900
Pb≦0.020
Si≦0.900
Ti≦1.800
Zr≦0.900
Zn≦0.020
Se≦0.010
Te≦0.010
where the sum of the percentages of these components is at least 0.25 wt % of the total alloy.

12. The electrical conductor according to claim 1, wherein the composition of said microalloyed aluminum comprises the following weight percentages:
Mg: 0.60-0.90
Si: 0.55-0.85
Al: rest

13. The electrical conductor according to claim 1, wherein the composition of said microalloyed aluminum comprises the following weight percentages
Zr: 0.15-0.25
Fe: 0.1-0.2
Zn: 0.01-0.015
Ti: 0.005
Al: rest

14. The electrical conductor according to claim 1, wherein said fluorinated polymer is polytetrafluoroethylene or a derivative thereof.

15. The electrical conductor according to claim 1, wherein said fluorinated polymer is polytetrafluoroethylene with heat resistant resins.

16. The electrical conductor according to claim 1, wherein the thickness of the dry film of said fluorinated polymer is comprised between 10 and 35 microns.

17. The conductor according to claim 1, wherein all the filamentary members thereof are made from microalloyed copper.

18. The conductor according to claim 1, wherein all the filamentary members thereof are made from microalloyed aluminum.

19. A process for the manufacture of an electrical conductor for the transmission of electrical power according to claim 1, wherein it comprises a step of coating at least one of said filamentary members with a fluorinated polymer and subsequent stranding of said electrical conductor.

20. The process according to claim 19, wherein said coating step includes a step of applying said fluorinated polymer by spraying, dipping or impregnation by means of rollers, and a curing step of said fluorinated polymer at a temperature of above 200° C., preferably above 220° C.

21. An overhead power line for the transmission of electrical power, wherein it comprises at least one conductor according to claim 1.

22. A submarine cable for the transmission of electrical power, wherein it comprises at least one conductor according to claim 1.
